(19) United States
(12) Patent Application Publication
(10) Pub. No.: US 2006/0099064 A1
(43) Pub. Date: May 11, 2006

(54) On-the-fly robotic stacking system for flat glass

(76) Inventors: Yaron Anaki, Serigim (IL); Arkady Nayman, Rishon Lezion (IL)

Correspondence Address: Mavis S. Gallenson, Esq.;c/o LADAS & PARRY, Suite 2100, 5670 Wilshire Boulevard, Los Angeles, CA, 90036-5679, US

(21) Appl. No.: 10/984,685

(22) Filed: Nov. 8, 2004

(51) Int. Cl. B65G 59/02

(52) U.S. Cl. 414/797

(57) ABSTRACT

An on-the-fly robotic system and method for unloading glass sheets of mixed sizes, including jumbo-sized sheets, from or onto a conveyor onto or from unloading platforms. The system comprises at least one traverse unit extending along the conveyor in parallel to the longitudinal axis thereof and at least two programmable industrial robots movably mounted on the traverse unit. The robots may be operated in a full synchronized mode for handling sheets too large or to heavy to be handled by a single robot or in an individual operation mode where each robot handles a single sheet.

### FIELD OF THE INVENTION

The present invention generally relates to system and method for handling heavy flat objects and in particular to a multi-purpose robotic system for handling and stacking flat glass sheets of mixed sizes directly off or onto a production line in an on-the-fly manner.

### BACKGROUND OF THE INVENTION

The present invention relates to automatic unloading and stacking of cut-glass sheets of multiple sizes at the cold-end of a float glass production line. In particular, the present invention is aimed at handling massive size glass sheets, having a full or half ribbon width cut to different lengths. Sheets of such dimensions are commonly known as jumbo-sized sheets for plates of full ribbon width and about 6 m long, as LES (lehr end size) sheets for plates of full ribbon width and about 2 to 3 m long, and as split size sheets (SSS) for plates of half ribbon width and 2 to 3 m long. Such plates and in particular the jumbo size plates, may reach a weight of more than 700 Kg. The issue addressed by the present invention is that of lifting the heavy fragile sheets from horizontal position and stacking them in a substantially vertical position on racks positioned on unloading platforms located along the conveyor side. The present invention also relates to the reverse operation, i.e., to the unloading of vertically positioned glass sheets from glass racks onto a substantially horizontal conveyor line, e.g., for further processing. The invention further addresses the handling of mixed size sheets where a combination of jumbo-sized, LES and split size sheets arrive to the unloading stations in a mixed order.

Until recently, unloading and stacking flat glass sheets off a float line and onto racks was performed either manually or by dedicated machines known as flat glass stackers. Glass stackers suffer from a number of drawbacks, most notably their inflexibility in handling glass sheets of various sizes and qualities and their inability to stack the plates in more than one orientation. Furthermore, known jumbo stackers occupy a large floor space and/or extend to a considerable height above the floor, putting heavy installation space demands. In recent years, the use of industrial robots for handling glass sheets off and onto production lines has started to replace conventional glass stackers. However, the transposing of heavy jumbo-size glass plates from or onto a conveyor still posts a challenge in the float glass industry. U.S. patent application Ser. No. 10/448,261, assigned to the assignee of the present invention, provides a robotic system that can interchangeably handle any combination of LES, split size and jumbo-sized sheets with a minimum requirement for operating personnel. The system comprises a pair of synchronized articulate robots that are movably mounted on a pair of parallel bridges running above and across the conveyor. However for already existing production lines, the U.S. Ser. No. 10/448,261 system might not always provide the best solution since it requires the installation of the bridges and might require the installation of a popup belts system for stopping the plates. The present invention provides an alternative on-the-fly system for handling glass sheets of mixed sizes that can be more easily incorporated into any existing and running float line with no interruption to the production process and with reduced set-up time. The ability to lift the glass sheets in an on-the-fly manner eliminates the need to align the plates, thus reduces the handling cycle time as well as potential glass damage. In general, the system configuration reduces the overall space requirements compared to existing stacking systems, enhances the efficiency, reliability and yield and reduces overhead and operating costs. Furthermore, the present system, being based on available programmable articulate industrial robots can be easily adapted to perform new tasks by appropriate programming.

### SUMMARY OF THE PRESENT INVENTION

The present invention provides an on-the-fly automatic robotic system and method for handling and transposing heavy massive glass sheets including jumbo-sized sheets. The system allows for interchangeably unloading SSS, LES and jumbo size glass directly off the float line and stacking them on racks in a substantially vertical position. The system also allows for the reverse operation, i.e., for unloading sheets from racks onto a conveyor line. The system further allows for repacking, i.e. taking a plate from one rack to another, as well.

The system comprises at least one traverse unit located along one side of the conveyor in parallel to the longitudinal axis thereof; at least two programmed-controlled articulated industrial robots movably mounted in an upright position on the traverse unit and a master computer in communication with the robots controllers, the master computer controls the operation of the at least two robots for allowing a synchronized mode of operation of two adjacent robots for handling glass sheets too heavy and/or too big to be handled by one robot or an individual stand-alone operation mode where each robot independently handles a single sheet. When in a synchronized operation mode, one robot is selected as master and the second robot is selected as slave. During synchronized mode of operation, the two adjacent robots perform a linear movement along the at least one traverse unit to increase and/or decrease the distance there between.

Preferably the robots are six-axis heavy payload industrial articulate robots, including a base, an arm, a wrist and a controller for controlling the movements of the robot. A gripping device connected to the wrist allows for gripping the glass sheets. Preferably, the gripping device is a vacuum gripper including a base frame and a plurality of suction cups supported on said base frame, wherein the plurality of suction cups are divided into multiple groups such that each group is controlled separately.

In accordance with one embodiment of the invention the each of the robots is mounted on a driven carriage coupled to a linear guiding rail. The carriage is provided with a driving unit, such as a pinion and racket, for allowing linear translatory movement of the robots each along the traverse unit.

The unloading platforms may include racks for stacking jumbo-sized, LES and split sized glass sheets in a substantially vertical position.

The system may further comprise edge-detecting measuring device for measuring offset of a glass sheet with respect to the conveyor axis. The edge-detecting measuring device may comprise stationary sensors located along or in the vicinity of the conveyor and/or movable sensors incorporated into the gripping device, movable along one or two of the gripping device axes.

The present invention further provides for on-the-fly method for unloading glass sheets of mixed sizes off a conveyor onto unloading platforms. The method comprises the steps of: receiving information regarding dimensions and designated unloading platform of an incoming glass sheet and determining in accordance with said information whether a synchronized operation mode or an independent operation mode is required for handling an incoming glass sheet. In an independent operation mode the method further comprises the steps of: moving each of the robots independently along the traverse unit to lift at least one glass sheet off the conveyor by the gripping device and to place the at least one glass sheet onto a designated unloading platform; and releasing the at least one glass sheet from the gripping device. In a synchronized operation mode the method further comprises the steps of: moving two adjacent robots along the traverse unit to be positioned at a predetermined distance apart; synchronously activating the gripping devices of the two adjacent robots to grip the incoming glass sheet; synchronously moving the robots, and manipulating the gripping devices to lift the glass sheet off the conveyor and to place the glass sheet onto the designated unloading platform; and synchronously releasing the glass sheet from the gripping devices onto the designated unloading platform; wherein the moving of the two adjacent robots along the traverse unit include a first linear movement away from each other followed by a second linear movement toward each other. In a synchronized operation mode, one of the two robots is selected to be master robot and the other is selected to be a slave robot.

### BRIEF DESCRIPTION OF THE DRAWINGS

The present invention will be understood and appreciated more fully from the following detailed description taken in conjunction with the drawings in which:

FIG. 1 is a schematic top view of a robotic stacking system in accordance with the present invention showing two robots operating in a synchronized mode for handling a jumbo-sized sheet;

FIG. 2 is a schematic top view of the system depicted in FIG. 1 during a stand-alone operation mode;

FIG. 3 is a photo taken of a model system in accordance with the invention showing a synchronized operation of two robots ready to lift up a glass plate from the conveyor;

FIG. 4 is a cross sectional view through a plane perpendicular to the conveyor axis passing through line 4-4 of FIG. 1;

FIGS. 5(i)-(ix) are top views of a system in accordance with the invention depicting in a sequential manner the synchronized motion of two robots during a cycle of synchronized operation for unloading a jumbo-sized glass sheet from the conveyor and stacking it in a substantially vertical orientation onto a rack;

FIG. 6(i)-(iv) are elevational perspective views of the system shown in FIG. 5 showing in a sequential manner four snap-shots during a cycle of synchronized operation;

FIG. 7 is a schematic illustration of a pair of rippers placed on a jumbo-sized glass;

FIG. 8 is a schematic top view of a robotic stacking system of the invention in accordance of another configuration.

### DETAILED DESCRIPTION OF THE PREFERRED EMBODIMENT

The present invention provides an on-the-fly robotic system with maximum versatility for handling a wide variety of glass plates of mixed sizes and qualities. In particular, the present system may be used for unloading jumbo-sized sheets, LES sheets, split size sheets or a combination thereof directly off a float line. The ability to handle a combination of mixed size sheets in an on-the-fly manner reduces the cycle time during operation and eliminates the need to install stopping and aligning mechanisms, thus reduces set up time and costs during installation as well. Generally, the present system and method reduces capital investment and operational costs.

The system is based on at least two programmable heavy payload industrial robots, preferably 6-axes articulate robots, with an additional translation axis for allowing linear movement of the robots along at least one traverse unit installed along the conveyor line in parallel to its longitudinal axis. The at least two robots may be operated in a fully synchronized operation mode for glass sheets which are too big to be handled by a single robot, or in an independent stand-alone operation mode when handling LES and/or split size sheets.

In the context of the present invention, jumbo-sized sheets generally refer to plates having sizes between 3600×2500 to 6100×3300 mm, LES sheets refer to plates of 1000×2400 to 2800×3600 mm and split size sheets refer to plates of 1200×1200 to 1800×2500 mm. However, it will be easily understood that plates of other dimensions can be handled by the present system, as well.

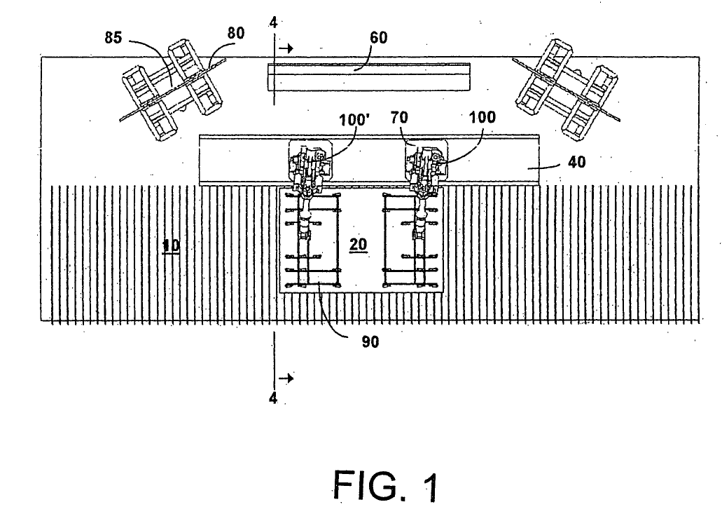

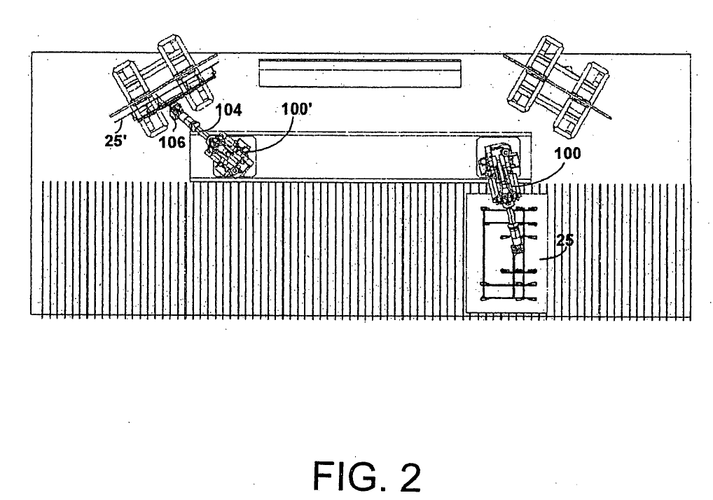

Referring now to the drawings, FIGS. 1 and 2 are schematic top views of a system in accordance with one embodiment of the invention. The system comprises two robots, 100 and 100′, movably mounted on a traverse unit 40 located along conveyor 10 in parallel thereto. Conveyor 10 comprising rollers 12 is continuously conveying glass sheets 20, preferably jumbo-sized and/or LES and or split-size glass sheets, along the conveyor longitudinal axis, hereinafter referred to as the conveyor main axis. Each of robots 100 is provided with a gripping device 90 adapted for grasping a glass sheet. Also shown are a rack 60 for stacking jumbo-sized plates and two racks 80 mounted on rotated tables 85 for stacking LES and/or SSS plates. FIG. 1 depicts the system in a synchronized operation mode where grippers 90 are positioned above a jumbo-sized plate 20. FIG. 2 depicts the system during individual stand-alone mode where the robots operate independently. Robot 100 is ready to lift up plate 25 from conveyor 10 while robot 100′ is placing plate 25′ on rack 80 is a schematic top view

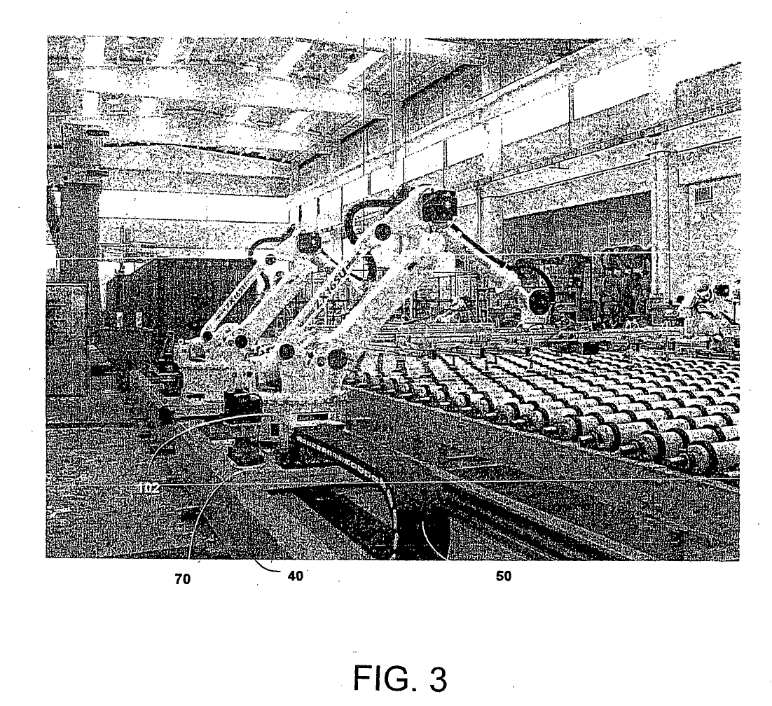

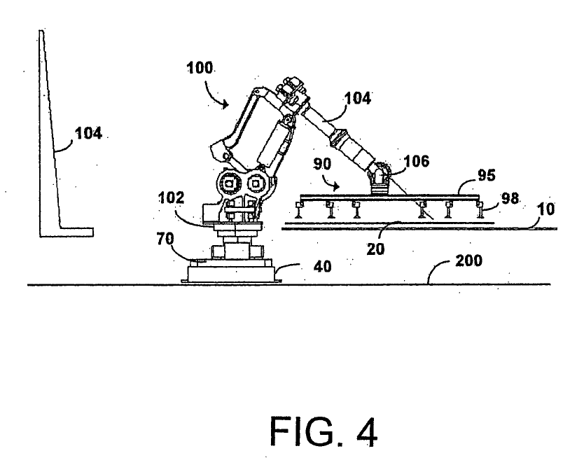

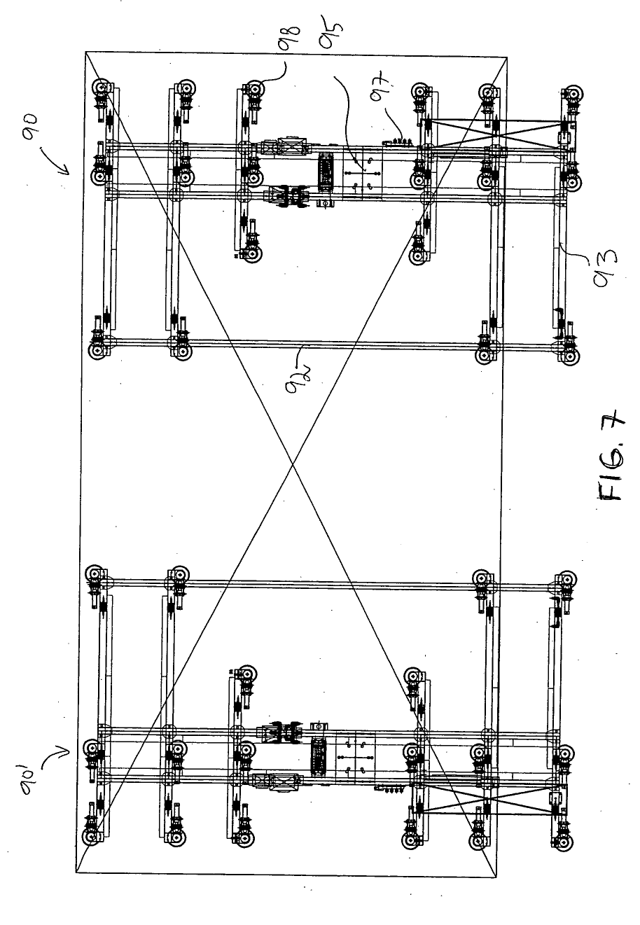

As best seen in FIGS. 3 and 4, Robots 100 are mounted in an upright position on a carriage 70 which is slidably mounted on traverse unit 40. Robots 100 are preferably identical heavy payload articulated industrial robots, including a base 102 supported on carriage 70, an arm 104 rotatble relative to base 102, a wrist 106 and a programmable controller (not shown) for controlling the robot movements. Preferably robot 100 is a 6-axis robot of a wide arm reach and a wide work envelope, comprising in addition to the rotational axis about the base, two arm joints and a three-axis wrist, such as for example the Kawasaki ZX series. Gripper device 90, shown in detail in FIG. 7, is connected via mechanical link 95 to wrist 106 for grasping the glass sheets. Gripper 90 comprises longitudinal bars 92, crossing bars 93 and a plurality of vacuum suction cups 98 connected thereto. The vacuum suction cups 98, coupled to a vacuum pump (not shown), are divided into multiple groups, which are activated automatically and independently according to the specific plate size and position, eliminating any need for manual setting. Vacuum cups 98 are supported on springs for allowing gentle grasping of the glass, decreasing damage and scratches. Also shown in FIG. 7 are mobile group of sensors 97 which are movably mounted on a longitudinal bar allowing the sensor to move along the bar for detecting the edge of a mounted plate after it is picked up by the gripper and during its trajectory to the designated rack.

Carriage 70 is slidably mounted on traverse unit 40 and is provided with a driving mechanism for actuating controllable traverse motion of robot 100 along unit 40 in parallel to conveyor 10. The sliding means (not shown) of carriage 70 allows for smooth, low friction and highly accurate linear motion. Carriage 70 is preferably further provided with end-detecting sensors for detecting ends of unit 40. Detailed examples for a driving mechanism, sliding means and end detecting means are given in U.S. patent application Ser. No. 10/448,261, the relevant parts thereof are incorporated herein by reference. However, it will be easily realized that the invention is not limited to the driving mechanism and/or to the sliding means and/or end detecting means described there and that other driving mechanisms for allowing smooth linear movement of carriage 70 along unit 40 and for detecting the end of the unit are possible without departing from the scope of the invention. The wiring required for robot 100 operation, including power supplying cables and communication lines to the robot controller are connected to the robot base 102 by means of cable chain 50 (best seen in FIG. 3).

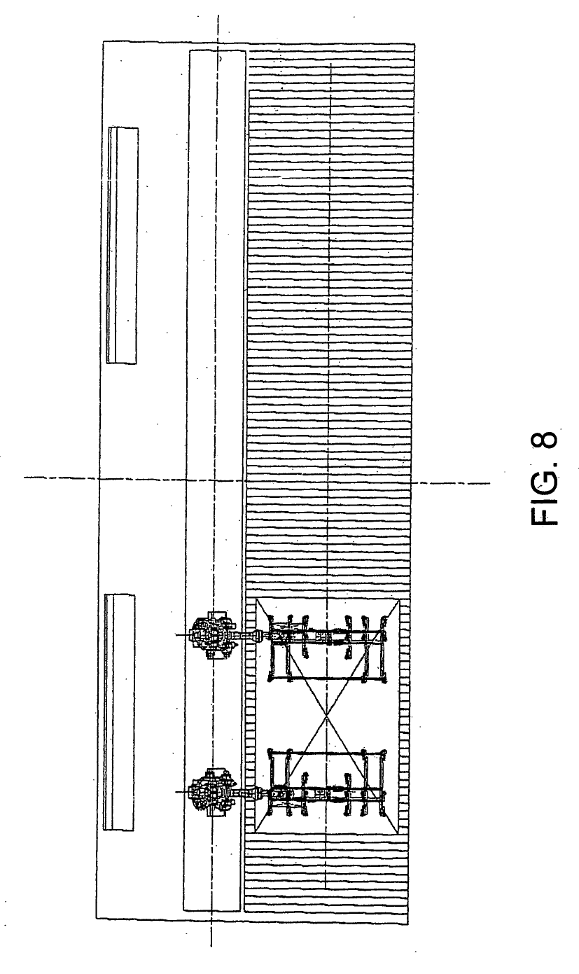

A master computer in communication with the controllers of robots 100 controls the robots operation. The master computer receives and analyzes information regarding customer order scheduling and determines which robot will handle which glass plate and when robots 100 should operate in full synchronization mode or in an independent mode. Accordingly, the master computer sends orders to robots 100 regarding incoming glass sheets and the desired rack for each sheet. The information regarding customer orders is preferably received in the master computer by direct connection to the production line mainframe computer. Alternatively, the information can be loaded locally to the master computer memory. The master computer further gathers data from sensors or from any other monitoring or diagnostic system that might be installed along the production line. Such a monitoring system may be, for example, a camera system installed above the production line prior to the unloading stations, which overviews the cut glass and measures the precise size and orientation of each coming glass sheet. The master computer may further control the glass racks management for allowing automated stock administration. Preferably the master computer is provided with a monitor panel for allowing manual initialization and control of stacking procedures. A detailed description of the computerized robots control network and the robot control programs is given in conjunction with FIG. 8-12 below of U.S. patent application Ser. No. 10/448,261 and is incorporated herein by reference.

During operation, each of the robot controllers receives from the master computer information regarding incoming glass sheet 20 to be handled by the robot, including the designated rack for the sheet stacking. Accordingly, each of the robot controllers processes the information and calculates the required trajectory of gripper 90 for performing the task. When a synchronized cooperation of the two robots is required for handling a jumbo-sized sheet, one robot is selected as a master robot and the other robot as a slave robot.

The present invention allows for the complete elimination of an aligning (squaring) mechanism by means of edge-detecting measuring device for detecting the edges of the glass plate. The edge-detecting measuring device may comprise stationary sensors located along or in the vicinity of the conveyor anywhere along the plate trajectory. Alternatively, or additionally, the sensors may be movable sensors incorporated into grippers 90, such as sensors 98 shown in FIG. 7, movable along one or two of the gripper main axis for detecting the plate edges while the plate is being manipulated by the gripper. Any offset in the plate positioning, as measured by the edge-detecting device, is calculated by the robot program to be compensated and corrected during the motion of grippers 90 such that the plates will be stacked precisely in spite of any such offset. The elimination of mechanical squaring offers the advantage of fewer mechanical elements and more importantly of preventing damage and abrasion that might be caused to the glass edge by the squaring stoppers.

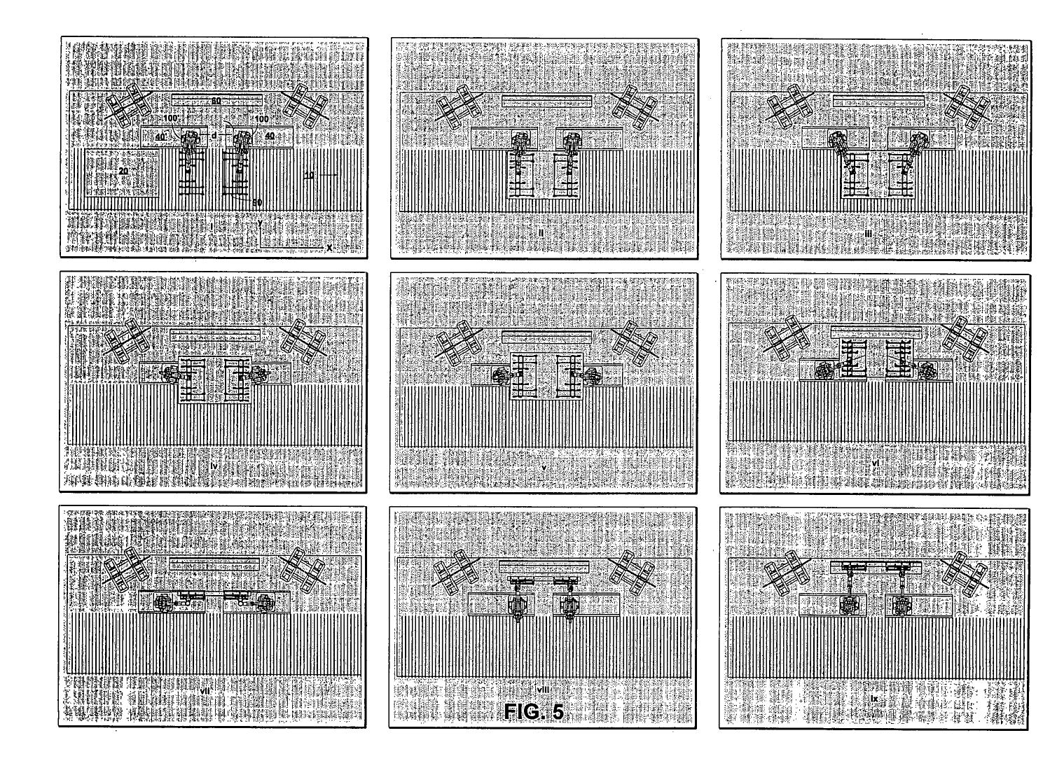

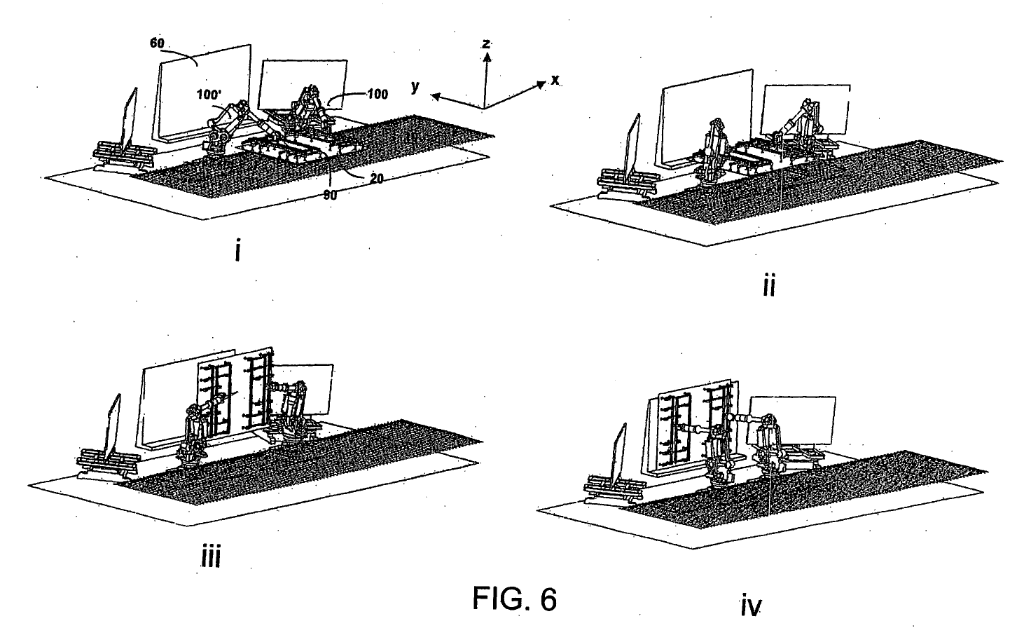

FIGS. 5 and 6 illustrate in a sequential manner the synchronized operation of two adjacent robots 100 and 100′ during a cycle of unloading a massive plate 20, too heavy and/or to big to be handled by a single robot, from conveyor 10 onto rack 60. In the configuration illustrated here, robots 100 and 100′ are mounted each on a separate traverse unit 40 and 40′, respectively.

When robots 100 and 100′ receive an order to pick up an incoming glass sheet 20, the robots first move inwardly toward each other, each along its respective unit 40, 40′ to stop at a predetermined distance d from each other. Distance d is determined in accordance with the longitudinal dimension of the incoming glass. At this point grippers 90 are oriented horizontally and synchronization starts. When sheet 20 arrives opposite grippers 90, the grippers are lowered while maintaining their horizontal orientation to contact the upper surface of sheet 20. When suction cups 98 are in contact with the glass sheet, vacuum is activated in selected groups of cups 98 in accordance with the sheet dimensions and orientation. When the vacuum reaches a predetermined level, the plate is lifted up to a predetermined height above conveyor 10. In order to facilitate on-the-fly operation, i.e. grasping and lifting plate 20 while it moves on conveyor 10, the robots' arms are slightly directed toward the incoming plate, such that grippers 90 are brought into contact with the plate slightly before the plate is centered between the robots bases, and are rotated to follow the exact plate position along conveyor 10 (along axis x) until the plate is lifted up. Thus, from the moment grippers 90 come in contact with the plate and until full vacuum is achieved, the relative velocity between conveyor 10 and grippers 90 is kept zero. During this period the robots arms move in parallel. When full vacuum is achieved, the robots start to move in a substantially mirror-like manner with respect to the vertical plane passing there between. When plate 20 reaches a predetermined height above conveyor 10, robots 100 and 100′ start to slide in the x and −x directions, respectively, to increase the distance between them, while plate 20 is moving in the y direction toward rack 60 and is continuously being lifted up in the z direction. When plate 20 reaches a predetermined position in the xy plane between conveyor 10 and rack 60 (FIG. 5(iv) the plate is rotated from a substantially horizontal to a substantially vertical orientation (FIG. 5v). Then robots 100 and 100′ start to move toward each other while moving plate 20 in its vertical orientation toward rack 60 until it is placed on the rack. Full synchronization between robots 100 ends after the glass sheet is already placed on the rack and the vacuum in vacuum cups 98 of both grippers 90 is released. It will be realized by persons skilled in the art that although the above description is given in a sequential manner, the robots can be programmed to perform the above operation in various ways.

It will be realized that the linear motion of the robots along traverse units 40 significantly increases the work envelope of the robots. The ability to increase and/or decrease the distance between the robots during synchronized operation allows the grippers to substantially cover the full width of the conveyor. This eliminates the need to move the plates perpendicularly to the conveyor axis in order to bring the plates within the robots reach, thus enabling an on-the-fly operation mode. It will be also realized that the linear motion of the robots allows for enhanced flexibility in positioning the unloading platforms along the conveyor as it increases the range of the possible distance between unloading platforms and conveyor as well as between adjacent unloading platforms. The ability to position the unloading platforms at an increased distance may facilitate accessibility to the unloading platforms by for example fork-lifts or fork trucks approaching the unloading platforms for loading/removing empty/full racks.

It will be realized that the positioning of the unloading platforms and of the racks mounted thereon is not limited to the configuration illustrated above and that rather, different configurations and a wide variety of racks may be employed. For instance two or more unloading Jumbo glass unloading stations located one next to the other (side by side) as shown in FIG. 8. Preferably, special sensors are used in the system, in order to define the rack position and orientation. Thus, once the rack position is detected, the robots can calculate the next plate target position by using the plate thickness parameter. This capability eliminates the need for heavy mechanical indexing platforms and civil work. The pack edge alignment may be achieved by using an optical sensor for detecting the exact edge position.

Although the above description refers mostly to unloading glass plates from a conveyor onto racks, it will be easily realized by persons skilled in the art that the present system can be used for the reverse operation, i.e., for transferring plates from a rack to the conveyor for applications where the plates packed at one location are going further processing at another location. It will be also realized that the present system may be used for repacking, i.e., for transferring glass plates from one rack to another.

It will be appreciated by persons skilled in the art that the present invention is not limited to what has been particularly shown and described hereinabove. Rather the scope of the present invention is defined only by the claims, which follow.

1. An on-the-fly robotic system for unloading glass sheets of mixed sizes from a conveyor onto unloading platforms and vice versa, the conveyor having a longitudinal axis along which the glass sheets are moving in a substantially horizontal orientation, the system comprising:
at least one traverse unit located along one side of the conveyor in parallel to the longitudinal axis thereof;
at least two programmed-controlled articulated industrial robots movably mounted in an upright position on said traverse unit for allowing linear movement of the at least two robots along said traverse unit, each robot includes an arm, a wrist, a gripping device connected to the wrist and a controller for controlling the movements of the robot; and
a master computer in communication with the robots controllers, the master computer controls the operation of the at least two robots for allowing a synchronized mode of operation of two adjacent robots for handling glass sheets too heavy and/or too big to be handled by one robot or an individual stand-alone operation mode where each robot independently handles a single sheet.

2. The system of claim 1 wherein in a synchronized mode of operation the two adjacent robots perform a linear movement along said at least one traverse unit to increase and/or decrease the distance there between.

3. The system of claim 1 wherein the unloading platforms include racks for stacking the glass sheets in a substantially vertical position.

4. The system of claim 1 wherein the glass sheets include jumbo-sized glass sheets.

5. The system of claim 1 wherein the glass sheets include LES and/or split size sheets.

6. The system of claim 1 wherein the robots are six-axis heavy payload industrial articulated robots.

7. The system of claim 1 wherein each of the robots is mounted on a driven carriage provided with a driving unit for allowing linear movement of the robot along the at least one traverse unit.

8. The system of claim 6 wherein the carriage is movably mounted on a linear guiding rail.

9. The system of claim 1 wherein each of the at least two robots is movably mounted on a separate traverse unit

10. The system of claim 1 further provided with edge-detecting measuring device for measuring offset of a glass sheet with respect to the conveyor axis.

11. The system of claim 10 wherein said edge-detecting measuring device comprises stationary sensors located along or in the vicinity of the conveyor.

12. The system of claim 10 wherein said edge-detecting measuring device comprises movable sensors incorporated into the gripping device, movable along one or two of the gripping device axes.

13. The system of claim 1 wherein said unloading platforms include a jumbo rack positioned in parallel to the longitudinal axis of the conveyor.

14. The system of claim 1 wherein said unloading platforms include LES or split size rack.

15. The system of claim 14 wherein said LES or split size rack is positioned in an angle to the longitudinal axis of the conveyor.

16. The system of claim 1 wherein the gripping device is a vacuum gripper including a base frame and a plurality of suction cups supported on said base frame.

17. The system of claim 6 wherein the plurality of suction cups are divided into multiple groups and wherein each groups is controlled separately.

18. The system of claim 1 wherein when in a synchronized operation mode, one of the two adjacent robots is selected to be master robot and the other is selected to be a slave robot.

19. A method for on-the-fly unloading glass sheets of mixed sizes off a conveyor and for stacking the glass sheets onto unloading platforms and for the reverse operation, the method comprising
installing at least one traverse unit along the conveyor in parallel to the longitudinal axis thereof;
providing at least two programmed-controlled industrial articulated robots movably mounted in an upright position on said at least one traverse unit for allowing linear movement of the at least two robots along the traverse unit, each robot includes an arm, a wrist, a gripping device connected to the wrist and a controller for controlling the movements of the robot; and
providing a master computer in communication with the robots controllers, the master computer controls the operation of the at least two robots for allowing a synchronized mode of operation of two adjacent robots for handling sheets too heavy and/or too big to be handled by a single robot, or an individual operation mode where each robot independently handles a single sheet.

20. The method of claim 19 wherein the glass sheets include jumbo-sized glass sheets.

21. The method of claim 20 wherein the glass sheets further include LES glass sheets or split size sheets.

22. The method of claim 19 wherein the robots are six-axis heavy payload industrial articulated robots.

23. The method of claim 19 wherein when in a synchronized operation mode, one of the two adjacent robots is selected to be master robot and the other is selected to be slave robot.

24. The method of claim 19 further comprising providing edge detecting measuring device for determining the location and orientation of a glass sheet on the conveyor.

25. A method for on-the-fly unloading glass sheets of mixed sizes off a conveyor onto unloading platforms in a system comprising at least one traverse unit extending along the conveyor in parallel to the longitudinal axis thereof and at least two program-controlled articulated robots movably mounted on the traverse unit, each of the robots is provided with a gripping device, the method comprising the steps of:
Receiving information regarding dimensions and designated unloading platform of an incoming glass sheet;
determining in accordance with said information whether a synchronized operation mode or an independent operation mode is required for handling an incoming glass sheet;
in an independent operation mode:
moving each of the robots independently along the traverse unit to lift at least one glass sheet off the conveyor by the gripping device and to place the at least one glass sheet onto a designated unloading platform; and
releasing the at least one glass sheet from the gripping device;
in a synchronized operation mode:
moving two adjacent robots along the traverse unit to be positioned at a predetermined distance apart;
synchronously activating the gripping devices of the two adjacent robots to grip the incoming glass sheet;
synchronously moving the robots along the traverse unit and manipulating the gripping devices to lift the glass sheet off the conveyor and to place the glass sheet onto the designated unloading platform; and
synchronously releasing the glass sheet from the gripping devices onto the designated unloading platform
wherein the moving of the two adjacent robots along the traverse unit include a first linear movement away from each other followed by a second linear movement toward each other.

26. The method of claim 25 wherein in a synchronized operation mode, one of the two robots is selected to be master robot and the other is selected to be a slave robot.
